(19) United States
(12) Patent Application Publication
(10) Pub. No.: US 2024/0232776 A1
(43) Pub. Date: Jul. 11, 2024

(54) ENTERPRISE SCREENING METHOD AND APPARATUS, ELECTRONIC DEVICE AND STORAGE MEDIUM

(71) Applicant: CHINESE RESEARCH ACADEMY OF ENVIRONMENTAL SCIENCES, Beijing (CN)

(72) Inventors: Jianglong CUI, Beijing (CN); Lieyu ZHANG, Beijing (CN); Guowen LI, Beijing (CN); Yijun BAO, Beijing (CN); Wensi WANG, Beijing (CN); Cao LIU, Beijing (CN); Xiaoguang LI, Beijing (CN); Jiaqian LI, Beijing (CN); Chen ZHAO, Beijing (CN); Caole LI, Beijing (CN); Wei LI, Beijing (CN); Xiaolin HOU, Beijing (CN)

(73) Assignee: CHINESE RESEARCH ACADEMY OF ENVIRONMENTAL SCIENCES, Beijing (CN)

(21) Appl. No.: 18/009,337

(22) PCT Filed: Oct. 25, 2022
(86) PCT No.: PCT/CN2022/127303

§ 371 Date: Dec. 9, 2022

(30) Foreign Application Priority Data
Aug. 26, 2021 (CN) 2021109892199

(51) Int. Cl. G06Q 10/0639; G06F 40/279

(52) U.S. Cl. CPC G06Q 10/06393; G06F 40/279

(57) ABSTRACT

An enterprise screening method and apparatus, an electronic device and a storage medium are provided. The method includes: acquiring original enterprise data belonging to a preset industry category, and extracting enterprise business behavior information corresponding to each enterprise from a business scope of each enterprise in the original enterprise data; extracting first target business behavior information from the business scope of the confirmed target enterprise data belonging to the preset industry category, the enterprise business behavior information and the first target business behavior information both including business mode information and business object information; and matching the enterprise business behavior information corresponding to each enterprise with the first target business behavior information respectively, and when the matching is successful, determining that the enterprise is a first target enterprise. An accuracy of enterprise screening can be improved.

### CROSS REFERENCE TO THE RELATED APPLICATIONS

This application is the national phase entry of International Application No. PCT/CN2022/127303, filed on Oct. 25, 2022, which is based upon and claims priority to Chinese Patent Application No. 2021109892199, filed on Aug. 26, 2021, the entire contents of which are incorporated herein by reference.

### TECHNICAL FIELD

The present disclosure relates to the technical field of environmental protection, in particular to an enterprise screening method and apparatus, an electronic device and a storage medium.

### BACKGROUND

In the past five years, pollution prevention and control efforts have been intensified, the utilization efficiency of resources and energy has been significantly improved, the ecological environment has been significantly improved, and the phased objectives and tasks of the tough battle against pollution have been completed. However, eco-environmental protection has a long way to go, and air pollution prevention and control work is still facing enormous real pressure. Finding out an actual situation of production and business of local enterprise is an important measure to achieve “precise pollution control”, and is also the basis for winning the tough battle against the air pollution. At present, the list of enterprises for air pollution environmental protection supervision is not accurate enough, and is lagging behind, which leads to inaccurate supervision objects.

### SUMMARY

### (I) Technical Problems to be Solved by the Present Disclosure

The technical problems to be solved by the present disclosure are that the list of enterprises for air pollution environmental protection supervision is not accurate enough, and is lagging behind, which leads to inaccurate supervision objects.

### (II) Technical Solutions

In order to solve the above technical problems or at least partially solve the above technical problems, the present disclosure provides an enterprise screening method and apparatus, an electronic device and a storage medium.

In a first aspect, the present disclosure provides an enterprise screening method, including:
acquiring original enterprise data belonging to a preset industry category, and extracting enterprise business behavior information corresponding to each enterprise from a business scope of each enterprise in the original enterprise data;
extracting first target business behavior information from the business scope of the confirmed target enterprise data belonging to the preset industry category, where the enterprise business behavior information and the first target business behavior information both include business mode information and business object information; and
for each enterprise, matching the enterprise business behavior information corresponding to the enterprise with the first target business behavior information, and when the matching is successful, determining that the enterprise is a first target enterprise.

In an optional embodiment, after determining that the enterprise is the first target enterprise, the method further includes:
matching each enterprise business behavior information corresponding to each enterprise except the first target enterprise in the original enterprise data with confirmed second target business behavior information respectively, and when the matching is successful, determining that the enterprise is a second target enterprise; and
taking a collection of the first target enterprise and the second target enterprise as a third target enterprise;
where, the second target business behavior information is matched with the preset industry category, and the second target business behavior information includes business mode information and business object information.

In an optional embodiment, the enterprise screening method further includes:
after determining the third target enterprise, determining an activation degree of the third target enterprise, and screening a fourth target enterprise from the third target enterprise based on the activation degree of the third target enterprise.

In an optional embodiment, a way of determining that the enterprise business behavior information and the first target business behavior information are successfully matched includes:
when the business mode information and the business object information in the enterprise business behavior information are the same as the business mode information and the business object information in the first target business behavior information respectively, determining that the matching between the enterprise business behavior information and the first target business behavior information is successful.

In an optional embodiment, the extracting the enterprise business behavior information corresponding to each enterprise from the business scope of each enterprise in the original enterprise data includes:
for each enterprise in the original enterprise data, segmenting each business scope of the enterprise to obtain a plurality of first segmentations;
when a part of speech of the first segmentation is a verb, taking the first segmentation as business mode information; and when the part of speech of the first segmentation is a noun, taking the first segmentation as business object information; and
taking a combination of the business mode information and the business object information as the enterprise business behavior information; and
the extracting the first target business behavior information from the business scope of the target enterprise data includes:
for each business scope in the target enterprise data, segmenting the business scope to obtain a plurality of second segmentations;
when a part of speech of the second segmentation is a verb, taking the second segmentation as business mode information; and when the part of speech of the second segmentation is a noun, taking the second segmentation as business object information; and
taking a combination of the business mode information and the business object information corresponding to each business scope in the target enterprise data as the first target business behavior information.

In an optional embodiment, the determining the activation degree of the third target enterprise includes:
acquiring activation degree index data of the third target enterprise in at least one dimension;
determining an activation degree of the activation degree index data in the dimension for the activation degree index data in each dimension; and
performing weighted average on the activation degree of the activation degree index data in the at least one dimension to determine the activation degree of the third target enterprise.

In an optional embodiment, the determining the activation degree of the activation degree index data in the dimension for the activation degree index data in each dimension includes:
for the activation degree index data in each dimension, when the activation degree index data in the dimension belongs to a numeric type, determining the activation degree of the activation degree index data in the dimension according to a size of the activation degree index data in the dimension; and
when the activation degree index data in the dimension belongs to a non-numeric type, determining the activation degree of the activation degree index data in the dimension according to existence of the activation degree index data in the dimension.

In a second aspect, the present disclosure provides enterprise screening apparatus, including:
an enterprise business behavior information extracting module configured for acquiring original enterprise data belonging to a preset industry category, and extracting enterprise business behavior information corresponding to each enterprise from a business scope of each enterprise in the original enterprise data;
a first target business behavior information extracting module configured for extracting first target business behavior information from the business scope of the confirmed target enterprise data belonging to the preset industry category, where the enterprise business behavior information and the first target business behavior information both include business mode information and business object information; and
a first target enterprise determining module configured for, for each enterprise, matching the enterprise business behavior information corresponding to the enterprise with the first target business behavior information, and when the matching is successful, determining that the enterprise is a first target enterprise.

In an optional embodiment, the enterprise screening apparatus further includes:
a second target enterprise determining module configured for matching each enterprise business behavior information corresponding to each enterprise except the first target enterprise in the original enterprise data with confirmed second target business behavior information respectively, and when the matching is successful, determining that the enterprise is a second target enterprise; and
a third target enterprise determining module configured for taking a collection of the first target enterprise and the second target enterprise as a third target enterprise;
where, the second target business behavior information is matched with the preset industry category, and the second target business behavior information includes business mode information and business object information.

In an optional embodiment, the enterprise screening apparatus further includes:
an activation degree determining module configured for, after determining the third target enterprise, determining an activation degree of the third target enterprise; and
a fourth target enterprise determining module configured for screening a fourth target enterprise from the third target enterprise based on the activation degree of the third target enterprise.

In an optional embodiment, the first target enterprise determining module is specifically configured for determining that the enterprise business behavior information and the first target business behavior information are successfully matched through the following way:

when the business mode information and the business object information in the enterprise business behavior information are the same as the business mode information and the business object information in the first target business behavior information respectively, determining that the matching between the enterprise business behavior information and the first target business behavior information is successful.

In an optional embodiment, the enterprise business behavior information extracting module is specifically configured for acquiring the original enterprise data belonging to the preset industry category, and for each enterprise in the original enterprise data, segmenting each business scope of the enterprise to obtain a plurality of first segmentations; when a part of speech of the first segmentation is a verb, taking the first segmentation as business mode information; and when the part of speech of the first segmentation is a noun, taking the first segmentation as business object information; and taking a combination of the business mode information and the business object information as the enterprise business behavior information; and
the first target business behavior information extracting module is specifically configured for, each business scope in the target enterprise data, segmenting the business scope to obtain a plurality of second segmentations; when a part of speech of the second segmentation is a verb, taking the second segmentation as business mode information; and when the part of speech of the second segmentation is a noun, taking the second segmentation as business object information; and taking a combination of the business mode information and the business object information corresponding to each business scope in the target enterprise data as the first target business behavior information.

In an optional embodiment, the activation degree determining module is specifically configured for acquiring activation degree index data of the third target enterprise in at least one dimension; determining an activation degree of the activation degree index data in the dimension for the activation degree index data in each dimension; and performing weighted average on the activation degree of the activation degree index data in the at least one dimension to determine the activation degree of the third target enterprise.

In an optional embodiment, the activation degree determining module is specifically configured for determining the activation degree of the activation degree index data in the dimension for the activation degree index data in each dimension through the following way:
for the activation degree index data in each dimension, when the activation degree index data in the dimension belongs to a numeric type, determining the activation degree of the activation degree index data in the dimension according to a size of the activation degree index data in the dimension; and when the activation degree index data in the dimension belongs to a non-numeric type, determining the activation degree of the activation degree index data in the dimension according to existence of the activation degree index data in the dimension.

In a third aspect, the present disclosure provides an electronic device, including: a processor, where the processor is configured for executing a computer program stored in a memory, and the computer program, when executed by the processor, implements the method according to the first aspect.

In a fourth aspect, the present disclosure provides a computer-readable storage medium storing a computer program thereon, where the computer program, when executed by a processor, implements the method according to the first aspect.

In a fifth aspect, the present disclosure provides a computer program product, where the computer program product, when running on a computer, enables the computer to execute the method according to the first aspect.

### (III) Beneficial Effects

Compared with the prior art, the technical solutions provided by the embodiments of the present disclosure have the following advantages.

The original enterprise data belonging to the preset industry category is acquired, the enterprise business behavior information corresponding to each enterprise is extracted from the business scope of each enterprise in the original enterprise data, and the first target business behavior information is extracted from the business scope of the confirmed (for example, confirmed by experts) target enterprise data. The enterprise business behavior information of each enterprise is matched with the first target business behavior information, and when the matching is successful, it is determined that the business scope of the enterprise also belongs to the preset industry category, and the enterprise is screened as the first target enterprise. As the enterprise business behavior information and the first target business behavior information both include the business mode information and the business object information, in this way, the business mode information and the business object information may be matched during the matching process, so as to improve a matching accuracy, so as to improve an accuracy of enterprise screening, and improve an accuracy of environmental protection supervision.

### BRIEF DESCRIPTION OF THE DRAWINGS

The accompanying drawings herein are incorporated into the specification and constitute a part of the specification, illustrate the embodiments in conformity with the present disclosure, and serve to explain the principles of the present disclosure together with the specification.

In order to illustrate the technical solutions in the embodiments of the present disclosure or in the related art more clearly, the following will briefly introduce the accompanying drawings needed to be used in the description of the embodiments or the related art; obviously, for those of ordinary skills in the art, other accompanying drawings may also be obtained from these accompanying drawings without creative efforts.

FIG. 1 is a flow chart of an enterprise screening method provided by the embodiments of the present disclosure;

FIG. 2 is another flow chart of the enterprise screening method provided by the embodiments of the present disclosure;

FIG. 3 is a schematic structural diagram of an enterprise screening apparatus provided by the embodiments of the present disclosure; and

FIG. 4 is a schematic structural diagram of an electronic device provided by the embodiments of the present disclosure.

### DETAILED DESCRIPTION OF THE EMBODIMENTS

In order to better understand the above objects, features and advantages of the present disclosure, the solutions of the present disclosure will be further described below. It should be noted that, in case of no conflict, the embodiments in the present disclosure and the features in the embodiments may be arbitrarily combined with each other.

In the following description, many specific details are set forth in order to fully understand the present disclosure, but the present disclosure may be implemented in other ways different from those described herein. Obviously, the embodiments described in the specification are merely a part of, rather than all of, the embodiments of the present disclosure.

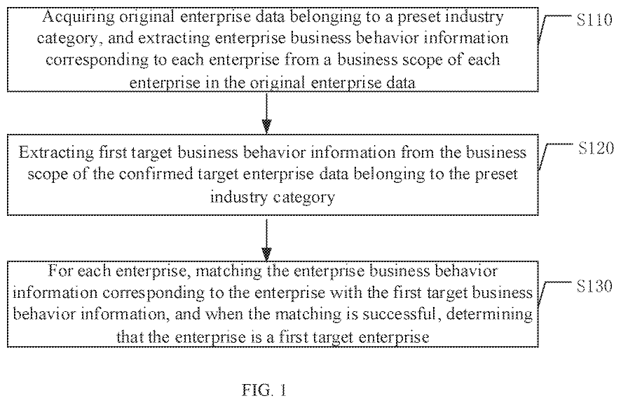

Referring to FIG. 1, FIG. 1 is a flow chart of an enterprise screening method in the embodiments of the present disclosure, where the method may include the following steps.

Step S110: acquiring original enterprise data belonging to a preset industry category, and extracting enterprise business behavior information corresponding to each enterprise from a business scope of each enterprise in the original enterprise data.

In the embodiments of the present disclosure, the original enterprise data belonging to the preset industry category may be acquired from the Internet through a big data technology, the preset industry category is an industry category to be supervised, may be an industry category confirmed by experts, and may be set according to actual requirements, for example, may be a national economy industry category of a “gas”-related enterprise, and the like. The original enterprise data includes enterprise information of a plurality of enterprises, and each enterprise may include: company name, unified social credit code, registration number, body name, body type, body status, date of establishment, registered capital currency, registered capital, industry category, industry type, location, business scope, business address, number of people, and the like.

Optionally, after acquiring the original enterprise data, the original enterprise data may be cleaned to ensure data quality. For example, invalid characters such as brackets, numerals, English words, symbols, and punctuations exist in a company name field, and text in the company name field may be structured by a text processing technology to delete invalid text such as brackets, numerals, English words, symbols, and punctuations. It may be understood that if invalid texts exist in other fields, the invalid texts may be deleted in the same manner.

Because the enterprise may have an irregular condition when registering information, for example, an industry to which the enterprise belongs is not accurately reported, information regarding production and business activities of the enterprise may be extracted through the business scope, and the extracted enterprise business behavior information may include: business mode information and business object information. The business mode information may refer to action information, for example, may be “production”, “sub-packaging”, “processing”, “manufacturing”, or the like. The business object information may refer to business contents, for example, may be “rubber”, “sanitary product”, agricultural and sideline products, or the like. By extracting the business mode information and the business object information, the production and business activities of the enterprise may be comprehensively and completely analyzed, so that an accuracy of enterprise screening is improved in the following information matching process.

In an optional embodiment, for each enterprise in the original enterprise data, each business scope of the enterprise may be segmented to obtain a plurality of first segmentations; when a part of speech of the second segmentation is a verb, the second segmentation is taken as business mode information; and when the part of speech of the second segmentation is a noun, the second segmentation is taken as business object information; and a combination of the business mode information and the business object information is taken as the enterprise business behavior information.

For example, if the business scope of the enterprise includes “manufacturing vehicle”, two first segmentations “manufacturing” and “vehicle” can be obtained by segmenting the “manufacturing vehicle”, and since the first segmentation “manufacturing” belongs to a verb, “manufacturing” may be taken as business mode information, “vehicle” belongs to a noun, so “vehicle” may be used as business object information.

Step S120: extracting first target business behavior information from the business scope of the confirmed target enterprise data belonging to the preset industry category.

The target enterprise data refers to the existing enterprise data which is confirmed by experts and belongs to the preset industry category. Similar to the above-mentioned way of extracting the enterprise business behavior information, the first target business behavior information may be extracted from the business scope of the target enterprise data. The first target business behavior information may similarly include: business mode information and business object information.

Specifically, for each business scope in the target enterprise data, the business scope is segmented to obtain a plurality of second segmentations; when a part of speech of the second segmentation is a verb, the second segmentation is taken as business mode information; and when the part of speech of the second segmentation is a noun, the second segmentation is taken as business object information; and a combination of the business mode information and the business object information corresponding to each business scope in the target enterprise data is taken as the first target business behavior information. It may be seen that the first target business behavior information is a collection of all the business behavior information corresponding to the business scopes in the target enterprise data.

Step S130: for each enterprise, matching the enterprise business behavior information corresponding to the enterprise with the first target business behavior information, and when the matching is successful, determining that the enterprise is a first target enterprise.

In the embodiments of the present disclosure, the way of matching the enterprise business behavior information of each enterprise with the first target business behavior information may be matching the business mode information and the business object information in the enterprise business behavior information with the business mode information and the business object information in the first target business behavior information respectively; when the matching is successful, it may be determined that the enterprise is the first target enterprise to be screened. Optionally, when the business mode information and the business object information in the enterprise business behavior information are the same as the business mode information and the business object information in the first target business behavior information respectively, it is determined that the matching between the enterprise business behavior information and the first target business behavior information is successful.

The enterprise screening method according to the embodiments of the present disclosure may acquire the original enterprise data belonging to the preset industry category, extract the enterprise business behavior information corresponding to each enterprise from the business scope of each enterprise in the original enterprise data, and extract the first target business behavior information from the business scope of the confirmed (for example, confirmed by experts) target enterprise data. The enterprise business behavior information of each enterprise is matched with the first target business behavior information, and when the matching is successful, it is determined that the business scope of the enterprise also belongs to the preset industry category, and the enterprise is screened as the first target enterprise. As the enterprise business behavior information and the first target business behavior information both include the business mode information and the business object information, in this way, the business mode information and the business object information may be matched during the matching process, so as to improve a matching accuracy, so as to improve an accuracy of enterprise screening, and improve an accuracy of environmental protection supervision.

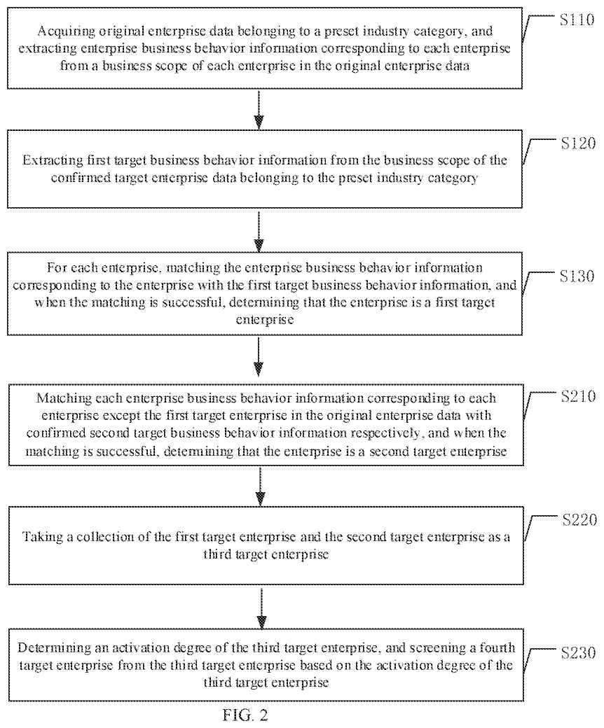

Referring to FIG. 2, FIG. 2 is another flow chart of the enterprise screening method in the embodiments of the present disclosure. Based on the embodiment of FIG. 1, the method may further include the following steps:

Step S210: matching each enterprise business behavior information corresponding to each enterprise except the first target enterprise in the original enterprise data with confirmed second target business behavior information respectively, and when the matching is successful, determining that the enterprise is a second target enterprise.

In the embodiments of the present disclosure, in order to further improve the accuracy of enterprise screening and avoid omissions, after determining the first target enterprise, the second target business behavior information which is corrected and supplemented by experts and matched with the preset industry category may be used for secondary matching of each enterprise business behavior information corresponding to each enterprise except the first target enterprise in the original enterprise data, so that all enterprises belonging to the preset industry category can be screened out. The second target business behavior information may also include: business mode information and business object information.

Step S220: taking a collection of the first target enterprise and the second target enterprise as a third target enterprise.

Compared with the first target enterprise, the third target enterprise contains more enterprises, so enterprises to be screened can be screened out more comprehensively and completely.

Step S230: determining an activation degree of the third target enterprise, and screening a fourth target enterprise from the third target enterprise based on the activation degree of the third target enterprise.

As shell enterprises and zombie enterprises do not have actual production and business activities, there are no production behaviors involving the preset industry category. It is necessary to remove the shell enterprises and the zombie enterprises in environmental protection supervision, so as to save manpower and obtain a more real enterprise situation. Therefore, after determining the third target enterprise, the activation degree of the third target enterprise may be determined, and then, the shell enterprises and the zombie enterprises may be effectively removed according to different activation degree level thresholds.

Specifically, activation degree index data of the third target enterprise in at least one dimension may be acquired. For example, the activation degree index data in the following dimensions may be acquired from the Internet: basic data of industry and commerce, and market supervision departments, data of other administrative departments (including tax data), recruitment information, media information, media publicity, website information, purchase transactions, capital operation, and the like.

For the activation degree index data in each dimension, an activation degree of the activation degree index data in the dimension is determined. The activation degree index data typically includes two types: a numeric type and a non-numeric type. The numeric type indicates a size of the activation degree index data, and a fractional value type may also be considered as a presence or absence type, that is, whether the activation degree index data exists or not. For the activation degree index data in each dimension, when the activation degree index data in the dimension belongs to a numeric type, the activation degree of the activation degree index data in the dimension is determined according to the size of the activation degree index data in the dimension.

For example, if the size of the activation degree index data is 0, 0 may be used as the activation degree of the activation degree index data. If the size of the activation degree index data is greater than 0 and less than a preset upper limit value, a product of a ratio of the size of the activation degree index data to the preset upper limit value and a first preset standard value (for example, 100, or the like) may be used as the activation degree of the activation degree index data. If the size of the activation degree index data is greater than or equal to the preset upper limit value, the first preset standard value may be used as the activation degree of the activation degree index data.

When the activation degree index data in the dimension belongs to a non-numeric type, the activation degree of the activation degree index data in the dimension is determined according to existence of the activation degree index data in the dimension. For example, if the activation degree index data in the dimension exists, a second preset standard value may be used as the activation degree of the activation degree index data, if the activation degree index data in the dimension does not exist, 0 may be used as the activation degree of the activation degree index data.

Weighted average is performed on the activation degree of the activation degree index data in the at least one dimension to determine the activation degree of the third target enterprise. Weights of the activation degree index data in each dimension may be obtained by expert scoring. Certainly, in the activation degree evaluation process, the above weights may also be adjusted according to the actual situation. In addition, the activation degree index data in each dimension may be further subdivided into a plurality of dimensions, and the corresponding weight is set for each dimension to improve an accuracy of determining the activation degree.

It may be understood that if the activation degree of the third target enterprise calculated consequently is 0, it is indicated that the third target enterprise is already cancelled. If the activation degree of the third target enterprise is not 0, it is indicated that the third target enterprise is not cancelled. In the embodiments of the present disclosure, a plurality of activation degree levels (for example, high activation degree level, medium activation degree and low activation degree) may be set according to the activation degree of each third target enterprise, and the third target enterprises are divided into different levels, so that the enterprises with different activation degrees can be subsequently analyzed. Different activation degree levels correspond to different activation degree scopes.

The lower the activation degree of the third target enterprise, the more likely the third target enterprise is to be a zombie enterprise or a shell enterprise. Therefore, the third target enterprise with the activation degree higher than a preset activation degree can be taken as the fourth target enterprise, or the corresponding activation degrees of the third target enterprises may be sorted from big to small, and the third target enterprises corresponding to the first N activation degrees can be taken as the fourth target enterprises, where N is a positive integer less than a total number of the third target enterprises.

According to the enterprise screening method of the embodiments of the present disclosure, after determining the first target enterprise is determined, the second target enterprise may be further screened out according to the second target business behavior information, and the collection of the first target enterprise and the second target enterprise may be taken as the third target enterprise, so as to improve comprehensiveness of enterprise screening. After that, the activation degree of the third target enterprise may be further analyzed to grasp a status of the enterprise from all directions, eliminate the zombie enterprises and the shell enterprises from the third target enterprise, improve an accuracy of the final selected fourth target enterprise, and then improve a targeting ability of supervision by environmental protection supervisors, thus saving labor costs. After that, the activation degree of the third target enterprise may be further analyzed to grasp a status of the enterprise from all directions, eliminate the zombie enterprises and the shell enterprises from the third target enterprise, improve an accuracy of the final selected fourth target enterprise, and then improve a targeting ability of supervision by environmental protection supervisors, thus saving labor costs.

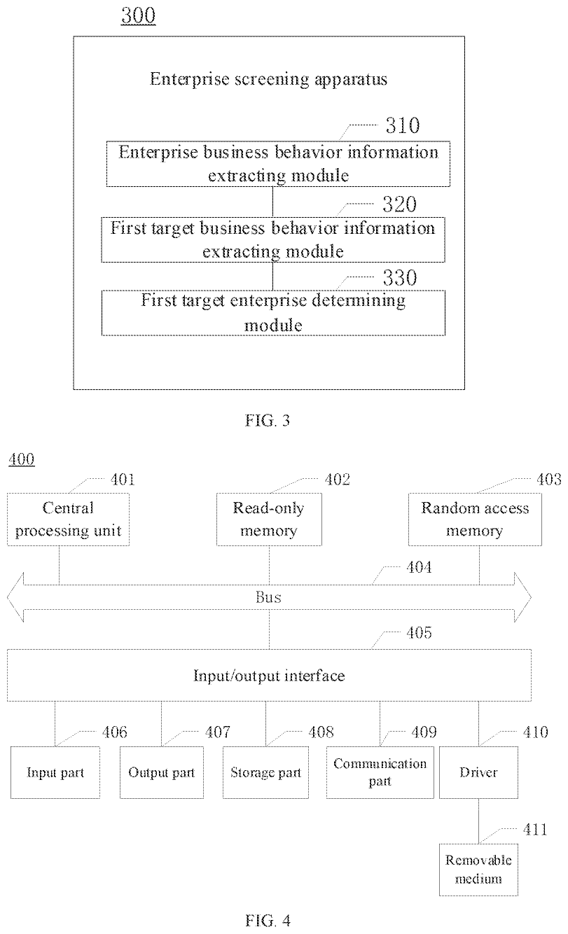

Corresponding to the above method embodiments, the embodiments of the present disclosure also provide an enterprise screening apparatus. Referring to FIG. 3, the enterprise screening apparatus 300 includes:
an enterprise business behavior information extracting module 310 configured for acquiring original enterprise data belonging to a preset industry category, and extracting enterprise business behavior information corresponding to each enterprise from a business scope of each enterprise in the original enterprise data;
a first target business behavior information extracting module 320 configured for extracting first target business behavior information from the business scope of the confirmed target enterprise data belonging to the preset industry category, where the enterprise business behavior information and the first target business behavior information both include business mode information and business object information, and
a first target enterprise determining module 330 configured for, for each enterprise, matching the enterprise business behavior information corresponding to the enterprise with the first target business behavior information, and when the matching is successful, determining that the enterprise is a first target enterprise.

In an optional embodiment, the above-mentioned enterprise screening apparatus further includes:
a second target enterprise determining module configured for matching each enterprise business behavior information corresponding to each enterprise except the first target enterprise in the original enterprise data with confirmed second target business behavior information respectively, and when the matching is successful, determining that the enterprise is a second target enterprise; and
a third target enterprise determining module configured for taking a collection of the first target enterprise and the second target enterprise as a third target enterprise;
where, the second target business behavior information is matched with the preset industry category, and the second target business behavior information includes business mode information and business object information.

In an optional embodiment, the above-mentioned enterprise screening apparatus further includes:
an activation degree determining module configured for, after determining the third target enterprise, determining an activation degree of the third target enterprise; and
a fourth target enterprise determining module configured for screening a fourth target enterprise from the third target enterprise based on the activation degree of the third target enterprise.

In an optional embodiment, the first target enterprise determining module is specifically configured for determining that the enterprise business behavior information and the first target business behavior information are successfully matched through the following way:
when the business mode information and the business object information in the enterprise business behavior information are the same as the business mode information and the business object information in the first target business behavior information respectively, determining that the matching between the enterprise business behavior information and the first target business behavior information is successful.

In an optional embodiment, the enterprise business behavior information extracting module is specifically configured for acquiring the original enterprise data belonging to the preset industry category, and for each enterprise in the original enterprise data, segmenting each business scope of the enterprise to obtain a plurality of first segmentations; when a part of speech of the first segmentation is a verb, taking the first segmentation as business mode information; and when the part of speech of the first segmentation is a noun, taking the first segmentation as business object information; and taking a combination of the business mode information and the business object information as the enterprise business behavior information; and
the first target business behavior information extracting module is specifically configured for, each business scope in the target enterprise data, segmenting the business scope to obtain a plurality of second segmentations; when a part of speech of the second segmentation is a verb, taking the second segmentation as business mode information; and when the part of speech of the second segmentation is a noun, taking the second segmentation as business object information; and taking a combination of the business mode information and the business object information corresponding to each business scope in the target enterprise data as the first target business behavior information.

In an optional embodiment, the activation degree determining module is specifically configured for acquiring activation degree index data of the third target enterprise in at least one dimension; determining an activation degree of the activation degree index data in the dimension for the activation degree index data in each dimension; and performing weighted average on the activation degree of the activation degree index data in the at least one dimension to determine the activation degree of the third target enterprise.

In an optional embodiment, the activation degree determining module is specifically configured for determining the activation degree of the activation degree index data in the dimension for the activation degree index data in each dimension through the following way:
for the activation degree index data in each dimension, when the activation degree index data in the dimension belongs to a numeric type, determining the activation degree of the activation degree index data in the dimension according to a size of the activation degree index data in the dimension; and when the activation degree index data in the dimension belongs to a non-numeric type, determining the activation degree of the activation degree index data in the dimension according to existence of the activation degree index data in the dimension.

The specific details of each module or unit in the apparatus above have been described in detail in the corresponding method, and thus will not be elaborated herein.

It should be noted that while a plurality of modules or units of the device for action execution have been mentioned in the detailed description above, this division is not mandatory. In fact, according to the embodiments of the present disclosure, the features and functions of the two or more modules or units described above may be embodied in one module or unit. On the contrary, the features and functions of one module or unit described above can be further divided into being embodied by more modules or units.

The embodiments of the present disclosure further provide an electronic device, including: a processor; a memory, configured for storing instructions executable by the processor; where, the processor is configured for executing the enterprise screening method above.

FIG. 4 is a schematic structural diagram of an electronic device provided by the embodiments of the present disclosure. It should be noted that the electronic device 400 illustrated in FIG. 4 is merely an example and should not impose any limitation on the function and range of application of the embodiments of the present disclosure.

As shown in the FIG. 4, the electronic device 400 includes a central processing unit (CPU) 401, which can perform various appropriate actions and processes according to a program stored in a read-only memory (ROM) 402 or loaded from a storage part 408 into a random access memory (RAM) 403. In the RAM 403, various programs and data needed for system operating may also be stored. The central processing unit 401, the ROM 402, and the RAM 403 are connected to each other through a bus 404. An input/output (I/O) interface 405 is also connected to the bus 404.

The following components are connected to the I/O interface 405: an input part 406 including a keyboard, a mouse, and the like; an output part 407 including, for example, a cathode ray tube (CRT), a liquid crystal display (LCD), a loud speaker and the like; a storage part 408 including a hard disk and the like; and a communication part 409 including a network interface card such as a local area network (LAN) card, a modem and the like. The communication part 409 performs communication processing via a network such as the Internet. A driver 410 is also connected to the I/O interface 405 as needed. A removable medium 411, such as a magnetic disk, an optical disk, a magneto-optical disk, a semiconductor memory, and the like, is installed on the driver 410 as needed, so that a computer program read therefrom can be installed into the storage part 408 as needed.

Particularly, according to the embodiments of the present disclosure, the process described above with reference to the flow chart can be implemented as a computer software program. For example, the embodiments of the present disclosure include a computer program product, which includes a computer program carried on a computer-readable medium, and the computer program contains a program code for executing the method shown in the flow chart. In such embodiments, the computer program may be downloaded and installed from the network through the communication part 409, and/or installed from the removable medium 411. When the computer program is executed by the central processing unit (CPU) 401, various functions defined in the apparatus of the present disclosure are executed.

The embodiments of the present disclosure further provide a computer-readable storage medium storing a computer program thereon, where the computer program, when executed by a processor, implements the enterprise screening method above.

It should be noted that the computer-readable storage medium shown in the present disclosure may be, for example, but is not limited to, an electronic, magnetic, optical, electromagnetic, infrared, or semiconductor system, apparatus, or device, or any combination of the above. More specific examples of the computer-readable storage medium may include, but are not limited to, an electrical connection with one or more wires, a portable computer disk, a hard disk, a random access memory, a read-only memory, an erasable programmable read only memory (EPROM or flash), an optical fiber, a portable compact disk read-only memory (CD-ROM), an optical memory device, a magnetic memory device, or any suitable combination of the above. In the present disclosure, the computer-readable storage medium may be any tangible medium containing or storing a program that may be used by or in connection with an instruction execution system, apparatus, or device. The program code contained on the computer-readable storage medium may be transmitted by any suitable medium, including but not limited to wireless, electric wire, optical cable, radio frequency, and the like, or any suitable combination of the above.

The embodiments of the present disclosure further provide a computer program product that, when running on a computer, causes the computer to perform the enterprise screening method above.

It should be noted that relational terms herein such as “first” and “second” and the like, are used merely to distinguish one entity or business from another entity or business, and do not necessarily require or imply there is any such relationship or order between these entities or operations. Furthermore, the terms “including”, “comprising” or any variations thereof are intended to embrace a non-exclusive inclusion, such that a process, method, article, or device including a plurality of elements includes not only those elements but also includes other elements not expressly listed, or also incudes elements inherent to such a process, method, article, or device. In the absence of further limitation, an element defined by the phrase “including a . . . ” does not exclude the presence of additional identical element in the process, method, article, or device.

The above are only specific embodiments of the present disclosure, so that those skilled in the art can understand or realize the present disclosure. Many modifications to these embodiments will be obvious to those skilled in the art, and the general principles defined herein can be implemented in other embodiments without departing from the spirit or scope of the present disclosure. Therefore, the present disclosure will not to be limited to these embodiments shown herein, but is to be in conformity with the widest scope consistent with the principles and novel features disclosed herein.

### INDUSTRIAL APPLICABILITY

The enterprise screening method provided by the embodiments of the present disclosure acquires the original enterprise data belonging to the preset industry category, extracts the enterprise business behavior information corresponding to each enterprise from the business scope of each enterprise in the original enterprise data, and extracts the first target business behavior information from the business scope of the confirmed (for example, confirmed by experts) target enterprise data. The enterprise business behavior information of each enterprise is matched with the first target business behavior information, and when the matching is successful, it is determined that the business scope of the enterprise also belongs to the preset industry category, and the enterprise is screened as the first target enterprise. As the enterprise business behavior information and the first target business behavior information both include the business mode information and the business object information, in this way, the business mode information and the business object information may be matched during the matching process, so as to improve a matching accuracy, so as to improve an accuracy of enterprise screening, and improve an accuracy of environmental protection supervision.

What is claimed is:

1. An enterprise screening method, comprising the following steps of:
acquiring original enterprise data belonging to a preset industry category, and extracting enterprise business behavior information corresponding to each enterprise from a business scope of each enterprise in the original enterprise data;
extracting first target business behavior information from the business scope of confirmed target enterprise data belonging to the preset industry category, wherein the enterprise business behavior information and the first target business behavior information both comprise business mode information and business object information; and
for each enterprise, matching the enterprise business behavior information corresponding to the enterprise with the first target business behavior information, and when the matching is successful, determining that the enterprise is a first target enterprise.

2. The method according to claim 1, wherein the method, after determining that the enterprise is the first target enterprise, further comprises:
matching each enterprise business behavior information corresponding to each enterprise except the first target enterprise in the original enterprise data with confirmed second target business behavior information respectively, and when the matching is successful, determining that the enterprise is a second target enterprise; and
taking a collection of the first target enterprise and the second target enterprise as a third target enterprise;
wherein, the second target business behavior information is matched with the preset industry category, and the second target business behavior information comprises business mode information and business object information.

3. The method according to claim 2, wherein the method further comprises:
after determining the third target enterprise, determining an activation degree of the third target enterprise, and screening a fourth target enterprise from the third target enterprise based on the activation degree of the third target enterprise.

4. The method according to claim 1, wherein a way of determining that the enterprise business behavior information and the first target business behavior information are successfully matched comprises:
when the business mode information and the business object information in the enterprise business behavior information are the same as the business mode information and the business object information in the first target business behavior information respectively, determining that the matching between the enterprise business behavior information and the first target business behavior information is successful.

5. The method according to claim 1, wherein the step of extracting the enterprise business behavior information corresponding to each enterprise from the business scope of each enterprise in the original enterprise data comprises:
for each enterprise in the original enterprise data, segmenting each business scope of the enterprise to obtain a plurality of first segmentations;
when a part of speech of the first segmentation is a verb, taking the first segmentation as first business mode information; and when the part of speech of the first segmentation is a noun, taking the first segmentation as first business object information; and
taking a combination of the first business mode information and the first business object information as the enterprise business behavior information; and
the step of extracting the first target business behavior information from the business scope of the target enterprise data comprises:
for each business scope in the target enterprise data, segmenting the business scope to obtain a plurality of second segmentations;
when a part of speech of the second segmentation is a verb, taking the second segmentation as second business mode information; and when the part of speech of the second segmentation is a noun, taking the second segmentation as second business object information; and
taking a combination of the second business mode information and the second business object information corresponding to each business scope in the target enterprise data as the first target business behavior information.

6. The method according to claim 3, wherein the step of determining the activation degree of the third target enterprise comprises:
acquiring activation degree index data of the third target enterprise in at least one dimension;
determining an activation degree of the activation degree index data in the dimension for the activation degree index data in each dimension; and
performing a weighted average on the activation degree of the activation degree index data in the at least one dimension to determine the activation degree of the third target enterprise.

7. The method according to claim 6, wherein the step of determining the activation degree of the activation degree index data in the dimension for the activation degree index data in each dimension comprises:
for the activation degree index data in each dimension, when the activation degree index data in the dimension belongs to a numeric type, determining the activation degree of the activation degree index data in the dimension according to a size of the activation degree index data in the dimension; and
when the activation degree index data in the dimension belongs to a non-numeric type, determining the activation degree of the activation degree index data in the dimension according to an existence of the activation degree index data in the dimension.

8. An enterprise screening apparatus, wherein the apparatus comprises:
an enterprise business behavior information extracting module, wherein the enterprise business behavior information extracting module is configured for acquiring original enterprise data belonging to a preset industry category, and extracting enterprise business behavior information corresponding to each enterprise from a business scope of each enterprise in the original enterprise data;
a first target business behavior information extracting module, wherein the first target business behavior information extracting module is configured for extracting first target business behavior information from the business scope of the confirmed target enterprise data belonging to the preset industry category, wherein the enterprise business behavior information and the first target business behavior information both comprise business mode information and business object information; and
a first target enterprise determining module, wherein the first target enterprise determining module is configured for matching, for each enterprise, the enterprise business behavior information corresponding to the enterprise with the first target business behavior information and determining that the enterprise is a first target enterprise when the matching is successful.

9. An electronic device, comprising: a processor, wherein the processor is configured for executing a computer program stored in a memory, and the computer program, when executed by the processor, implements the steps of the method according to claim 1.

10. A computer-readable storage medium storing a computer program thereon, wherein the computer program, when executed by a processor, implements the steps of the method according to claim 1.

11. The electronic device according to claim 9, wherein the method, after determining that the enterprise is the first target enterprise, further comprises:
matching each enterprise business behavior information corresponding to each enterprise except the first target enterprise in the original enterprise data with confirmed second target business behavior information respectively, and when the matching is successful, determining that the enterprise is a second target enterprise; and
taking a collection of the first target enterprise and the second target enterprise as a third target enterprise;
wherein, the second target business behavior information is matched with the preset industry category, and the second target business behavior information comprises business mode information and business object information.

12. The electronic device according to claim 11, wherein the method further comprises:
after determining the third target enterprise, determining an activation degree of the third target enterprise, and screening a fourth target enterprise from the third target enterprise based on the activation degree of the third target enterprise.

13. The electronic device according to claim 9, wherein in the method, a way of determining that the enterprise business behavior information and the first target business behavior information are successfully matched comprises:
when the business mode information and the business object information in the enterprise business behavior information are the same as the business mode information and the business object information in the first target business behavior information respectively, determining that the matching between the enterprise business behavior information and the first target business behavior information is successful.

14. The electronic device according to claim 9, wherein in the method, the step of extracting the enterprise business behavior information corresponding to each enterprise from the business scope of each enterprise in the original enterprise data comprises:
for each enterprise in the original enterprise data, segmenting each business scope of the enterprise to obtain a plurality of first segmentations;
when a part of speech of the first segmentation is a verb, taking the first segmentation as first business mode information; and when the part of speech of the first segmentation is a noun, taking the first segmentation as first business object information; and
taking a combination of the first business mode information and the first business object information as the enterprise business behavior information; and
the step of extracting the first target business behavior information from the business scope of the target enterprise data comprises:
for each business scope in the target enterprise data, segmenting the business scope to obtain a plurality of second segmentations;
when a part of speech of the second segmentation is a verb, taking the second segmentation as second business mode information; and when the part of speech of the second segmentation is a noun, taking the second segmentation as second business object information; and
taking a combination of the second business mode information and the second business object information corresponding to each business scope in the target enterprise data as the first target business behavior information.

15. The electronic device according to claim 12, wherein in the method, the step of determining the activation degree of the third target enterprise comprises:
acquiring activation degree index data of the third target enterprise in at least one dimension;
determining an activation degree of the activation degree index data in the dimension for the activation degree index data in each dimension; and
performing a weighted average on the activation degree of the activation degree index data in the at least one dimension to determine the activation degree of the third target enterprise.

16. The electronic device according to claim 15, wherein in the method, the step of determining the activation degree of the activation degree index data in the dimension for the activation degree index data in each dimension comprises:
for the activation degree index data in each dimension, when the activation degree index data in the dimension belongs to a numeric type, determining the activation degree of the activation degree index data in the dimension according to a size of the activation degree index data in the dimension; and
when the activation degree index data in the dimension belongs to a non-numeric type, determining the activation degree of the activation degree index data in the dimension according to an existence of the activation degree index data in the dimension.

17. The computer-readable storage medium according to claim 10, wherein the method, after determining that the enterprise is the first target enterprise, further comprises:
matching each enterprise business behavior information corresponding to each enterprise except the first target enterprise in the original enterprise data with confirmed second target business behavior information respectively, and when the matching is successful, determining that the enterprise is a second target enterprise; and
taking a collection of the first target enterprise and the second target enterprise as a third target enterprise;
wherein, the second target business behavior information is matched with the preset industry category, and the second target business behavior information comprises business mode information and business object information.

18. The computer-readable storage medium according to claim 17, wherein the method further comprises:
after determining the third target enterprise, determining an activation degree of the third target enterprise, and screening a fourth target enterprise from the third target enterprise based on the activation degree of the third target enterprise.

19. The computer-readable storage medium according to claim 10, wherein in the method, a way of determining that the enterprise business behavior information and the first target business behavior information are successfully matched comprises:
when the business mode information and the business object information in the enterprise business behavior information are the same as the business mode information and the business object information in the first target business behavior information respectively, determining that the matching between the enterprise business behavior information and the first target business behavior information is successful.

20. The computer-readable storage medium according to claim 10, wherein in the method, the step of extracting the enterprise business behavior information corresponding to each enterprise from the business scope of each enterprise in the original enterprise data comprises:
for each enterprise in the original enterprise data, segmenting each business scope of the enterprise to obtain a plurality of first segmentations;
when a part of speech of the first segmentation is a verb, taking the first segmentation as first business mode information; and when the part of speech of the first segmentation is a noun, taking the first segmentation as first business object information; and
taking a combination of the first business mode information and the first business object information as the enterprise business behavior information; and
the step of extracting the first target business behavior information from the business scope of the target enterprise data comprises:
for each business scope in the target enterprise data, segmenting the business scope to obtain a plurality of second segmentations;
when a part of speech of the second segmentation is a verb, taking the second segmentation as second business mode information; and when the part of speech of the second segmentation is a noun, taking the second segmentation as second business object information; and
taking a combination of the second business mode information and the second business object information corresponding to each business scope in the target enterprise data as the first target business behavior information.
